(19) United States
(12) Patent Application Publication
(10) Pub. No.: US 2009/0101658 A1
(43) Pub. Date: Apr. 23, 2009

(54) Pressure-Resistant Body That is Supplied With Fluid

(76) Inventors: Karl Maile, Stuttgart (DE); Karl Berreth, Stuttgart (DE); Abram Lyutovich, Stuttgart (DE); Roland Weiss, Huttenberg (DE); Thorsten Scheibel, Bad Nauheim (DE); Marco Ebert, Wetter (DE); Martin Henrich, Wetzlar (DE); Andreas Lauer, Kirchhain (DE)

Correspondence Address: DENNISON, SCHULTZ & MACDONALD, 1727 KING STREET, SUITE 105, ALEXANDRIA, VA, 22314, US

(21) Appl. No.: 12/227,169

(22) PCT Filed: May 10, 2007
(86) PCT No.: PCT/EP2007/054537

§ 371 Date: Dec. 23, 2008

(30) Foreign Application Priority Data
May 10, 2006 (DE) 10 2006 022 055.6
Aug. 18, 2006 (DE) 10 2006 038 713.9

(51) Int. Cl. F17C 1/06; F16J 12/00

(52) U.S. Cl. 220/590

(57) ABSTRACT

The invention relates to a pressure-resistant body (10), such as a pressure pipe or pressure container, consisting of a steel base body (12), a first layer (14) of a ceramic fiber composite that surrounds the exterior of the base body and at least one second layer (16) of a fiber-reinforced plastic and/or a fiber-reinforced ceramic that is situated on the first layer.

The invention relates to a pressure-proof fluid-chargeable or fluid-charged body such as a pressure pipe or pressure vessel.

The efficiency of steam turbine processes is dependent on the process temperature. Consequently, one strives to set the process temperature as high as possible. Pressure-proof bodies, such as pressure pipes or pressure vessels, that are employed in these steam-turbine processes are produced, according to the state of technology, from martensitic steels or high-alloyed nickel-base alloys. The use of these materials allows process temperatures of up to 650° C. or 700° C. to be achieved. However, for safety reason one usually does not exceed a temperature of 620° C. for martensitic steels.

Bodies made of the above-mentioned steels can bear pressures up to 300 bar. Higher temperatures and pressures are not viable, due to a required stability against the material's creep behaviour, and on account of safety and economic reasons.

The present invention is based on the problem of further developing a pressure-proof fluid-chargeable or fluid-charged body, such as a pressure pipe or pressure vessel, in a way that allows an increase of the process temperature relative to bodies consisting of steel. Moreover, the bodies should be chargeable with pressures higher than those normally before employed.

As solution to this problem, the invention proposes a pressure-proof fluid-chargeable or fluid-charged body, such as a pressure pipe or pressure vessel, comprising a base body of steel, a first layer of ceramic fibre composite material, which encloses the exterior of the base body, and one or several second layers of fibre-reinforced ceramic and/or fibre-reinforced plastic arranged on the first layer.

Fluid-chargeable or fluid-charged bodies such as pressure pipes or pressure vessels according to the invention, allow an increase in process temperatures relative to bodies consisting exclusively of steel. In addition, higher pressure levels can be admitted than is currently possible. According to the invention, this is achieved as a result of the functional segregation of tightness and emergency characteristics of the steel pipe on the one hand and the high-temperature creep resistance of the fibre composite material on the other hand.

The invention provides a multi-layer body, which in particular in steam turbine processes offers the possibility of increasing the process temperature by at least 200° C. in comparison to processes employing current materials, which allows approximately a 7% increase in the thermal efficiency of power plants. A corresponding composite pipe exhibits good compressive and tensile load responses in both axial and radial directions and temperature stability up to a region between 900° C. and 1000° C. The first layer, comprising fibre composite material, has a thermo-insulating effect, i.e. it creates a temperature gradient between the steel pipe and the outer layer, so that the latter does not oxidize. In addition, economic manufacture is possible.

The use of ceramic fibre composite materials (Ceramic Matrix Composites (CMC)) under high-temperature conditions is known. CMC materials are employed in gas turbines in areas with hot gases, i.e. the turbine combustor, the static guide vanes that direct the gas flow, and the actual turbine blades that drive the compressor of the gas turbine. However, the corresponding components consist exclusively of CMC materials and do not possess the layered structure according to the invention. However, it is this layered structure that ensures that use at high temperatures up to 1000° C. and pressures of 300 bar and more can be reliably employed, and at the same time ensures a creep stability of the body for at least 30 years.

Thermal fibre composite materials are characterized by a ceramic matrix that is embedded between ceramic fibres, in particular long fibres, and is reinforced by these ceramic fibres. Consequently one uses names such as fibre-reinforced ceramic, composite ceramic, or simply fibre ceramic. Matrix and fibres in principle can consist of any of the known ceramic materials, carbon also being considered, in this context, as a ceramic material.

In particular, it is intended that the fibres of the ceramic composite material be aluminum oxide, mullite, silicon carbide, zircon oxide, and/or carbon fibres. The mullite consists of mixed crystals of aluminum oxide and silicon dioxide.

As ceramic matrix composites one preferably employs SiC/SiC, C/C, C/SiC, Al₂O₃/Al₂O₃, and/or mullite/mullite. Here the material in front of the forward-slash designates the fibre type, while the material after the forward slash designates the matrix type. As matrix system for the ceramic fibre composite structure one can also employ siloxane, Si precursors, and a large variety of oxides, such as for example zircon oxide.

Preferably, the first layer has a thickness D₁ with 1 mm≦D₁≦20 mm and/or the second layer or the second layers together has a thickness D₂ with 0 mm≦D_{2≦}50 mm.

For the purpose of achieving the desired armouring by means of the at least one second layer, the fibres of the fibre-reinforced carbon can be arranged on top of the first layer in a radially revolving and/or criss-crossing pattern. Likewise, the fibres of the first layer can be deposited on the base body in a radially revolving and/or criss-crossing pattern.

The base body preferably comprises martensitic steel or high-alloyed nickel-base alloy. Preferred values of the wall thickness D₃ are 2 mm≦D_{3≦}50 mm, without the scope of the invention's technical teaching being thereby limited.

The fibre volume Fv of the first layer should be in a range 30%≦Fv≦70%. The porosity P of the first layer preferably is in a range 5%≦P≦50%.

The ceramic matrix composite can be manufactured via CVI (Chemical Vapour Infiltration) processes, pyrolysis, in particular LPI (Liquid Polymer Infiltration) processes, or in a chemical reaction such as a LSI (Liquid Silicon Infiltration) process.

Preferably one employs as matrix material a precursor on Si basis, which is then transformed to SiC via pyrolysis. Si-based precursors offer the advantage of being easy to harden and to pyrolyse, which allows problem-free manufacturing.

The invention generally is distinguished by a pressure-proof fluid-chargeable or fluid-charged body, such as a pressure pipe or pressure vessel of steel, and a layer that encloses the base body and comprises or contains fibres, which exhibit no or only minimal creep at a temperature T with T≧500° C.

One employs creep-resistant fibres, i.e. fibres that in the creep domain—in the temperature region above 550° C.—exhibit no or only minimal increase over time of the plastic deformation, i.e. creep, which in turn prevents creep of the interior steel pipe. Chemically, the fibres are then to be characterized by a high creep strength, so the strength is ensured in particular in atmospheric air at high operating temperatures.

Fibres which come into question are reinforcing fibres that are members of the groups of oxidic, carbidic, and nitridic fibres or C fibres and SIBCN fibres. Plastic fibres such as PAN fibres or polyacrylonitrile fibres can also be referred to as reinforcing fibres.

Further details, advantages, and features of the invention are not only found in the claims and the characteristic features listed therein, on their own and/or in combination, but also in the following description of preferred embodiment examples illustrated in the drawing.

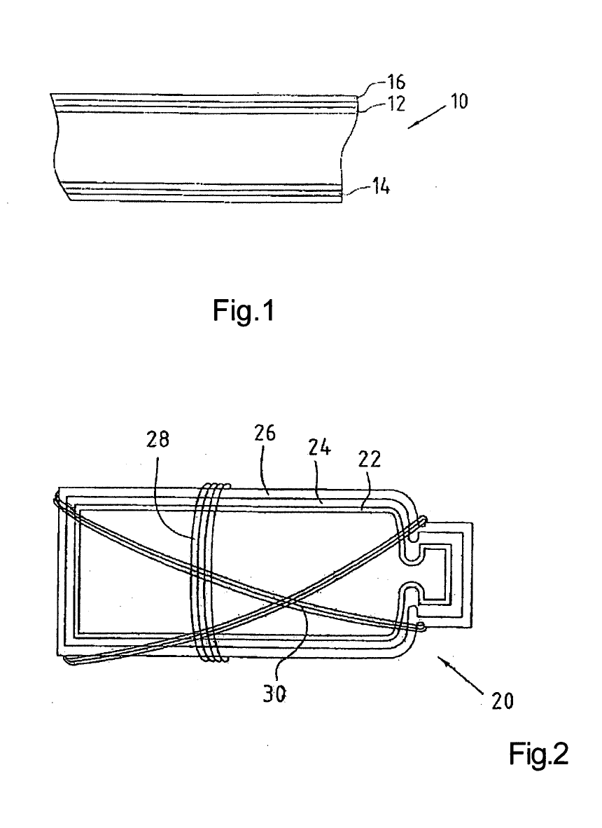

FIG. 1 shows a schematic view of a pressure pipe and

FIG. 2 shows a schematic view of a vessel.

FIG. 1 shows a sectional view of a pressure pipe 10, which in particular is used in power stations for steam turbine processes. In order to be able to allow fluids at pressures up to 300 bar or more and at temperatures of 800°, in particular 850° or higher, to pass through the pressure pipe 10, the pipe 10 is embodied as a composite pipe. The pipe 10 consists of a base body 12 of steel, onto which at least two layers 14, 16 have been applied. The layer 14, which is applied onto the base body 12 and is referred to as first layer, consists of a ceramic matrix composite, while the second layer 16 that covers the first layer 14 consists of fibre-reinforced plastic and/or fibre-reinforced ceramic. The plastic component serves to increase expansion compatibility.

The ceramic matrix composite of the first layer 14 can consist of known ceramic materials, whereby preferably SiC/SiC, Al₂O₃/Al₂O₃, or mullite/mullite should be mentioned. The first layer 14 of ceramic matrix composite ensures the creation of a thermal insulation between the base body 12 and the at least one second layer 16 of fibre-reinforced plastic, be this carbon-fibre reinforced plastic or glass-fibre reinforced plastic, to such a degree that oxidation of the at least one second layer 16 does not take place. This ensures that the at least one second layer 16 offers the desired armouring, so that the composite pipe 10 can be subjected to the desired high pressure levels. The second layer is also responsible for generating the prestress of the pressure pipe or pressure vessel, the prestressing increasing as applied temperatures increase.

In regard to prestress, it should be noted that prestress develops during start-up as pressure and temperature rise in the fibre wrap, and over time is partially reduced as a function of the creep behaviour of the internal steel pipe.

The first layer 14 makes it possible that the composite pipe 10—for the purpose of increased efficiency—can be subjected to the necessary high temperatures of at least 800° C.-850° C., possibly to 1000° C.

The fibres of the first layer 14 can be deposited in a manner reflecting requirements. Thus, the fibres can surround the base body 12 in a criss-crossing and/or radially revolving manner. The same applies with respect to the fibres of the at least one second layer 16.

FIG. 2 shows a purely schematic illustration of a pressure vessel 18, which also is composed of a base body 20 of steel and first and second layers 24, 26 arranged on the base body 20, the first layer 24 consisting of a ceramic matrix composite and the at least one second layer 26 consists of fibre-reinforced plastic and/or fibre-reinforced ceramic. The manufacturing processes and materials described above can also be employed in this case. Purely as an example, FIG. 2 illustrates fibres 28, 30 of the first layer 24, which have been deposited on the base body 22 in a radially revolving (long fibres 28) or criss-crossing (long fibres 30) pattern. Also feasible are other fibre patterns known in the art.

In the embodiment example of FIG. 1, the base body 12 can possesses, for example, an inside diameter of 500 mm and a wall thickness of 40 mm. The first layer 14—consisting of the ceramic matrix composite—has a thickness D₁≈10 mm, while the second layer 16—consisting of fibre-reinforced carbon—has a thickness D_{2≈}10 mm.

In the pressure vessel 20 of FIG. 2, the base body 22 can have a diameter of 300 mm, a length of 500 mm, as well as a wall thickness of 30 mm. The first layer 24 can have a thickness D₁, where D₁≈15 mm, and the second layer 26 can have a thickness D₂, where D₂≈10 mm, to provide figures purely as an example.

According to the invention, the thickness D of the fibre encasing relates to the wall thickness d of the pressure vessel 20 as 0.4 d≦D≦0.6, in particular d/2=D.

Such composite pipes 10 or composite vessels 20 can be charged with fluids at a temperature of approximately 850°, allowing utilization at high temperatures, in particular in steam turbine processes, whereby—relative to pressure pipes or pressure vessels of conventional design—the thermal efficiency can be substantially increased. At the same time, such composite bodies exhibit damage-enduring well-behaved breaking failure behaviour and a creep resistance. Compressive and tensile stresses in both axial and radial directions are possible without damaging the body. Moreover, an economic manufacture is possible.

Even though the embodiment examples have been explained using a base body with a first and a second layer applied to the latter, it is still in the scope of the invention if onto the base body only one layer of reinforcing fibres is deposited, which in the temperature region above 550° C. exhibits no or only a minimal increase over time of the plastic deformation, i.e. creep, which in turn arrests creep of the interior base body. The corresponding fibres also exhibit high creep strength, this strength being ensured at high operating temperatures—in particular in atmospheric air conditions. The corresponding fibres can be grouped in the categories oxidic, carbidic, or nitridic fibres, or C fibres or SIBCN fibres. Plastic fibres, such as PAN or polyacrylonitrile fibres, are feasible as well.

In particular, the following fibres are to be mentioned: C fibres, Nextel fibres, 3M fibres, Hi-Nicalon fibres, oxidic fibres, SiO₂, Al₂O₃, SiC, SIBCN, PAN, and Si₃N₄ fibres.

An example of the use of such a body is, for example, a boiler tube that can consist of austenitic or martensitic steel (9% chromium steel), which for example has an outside diameter of approximately 42 mm and a wall thickness of approximately 6 mm. In order to achieve the desired characteristics, this can be covered by a layer of the above-specified reinforcing fibres with a layer thickness in a range between 3 mm and 4 mm.

1-14. (canceled)

15. A pressure-proof, fluid-charged or fluid-chargeable body (10, 20) in the form of a pressure pipe or pressure vessel, said body comprising a base body (12, 22) of steel, a first layer (14, 24) of a ceramic matrix composite which immediately encloses the outside of the base body, and at least one second layer (16, 26) of fiber-reinforced plastic and/or fiber-reinforced ceramic, which is arranged on the first layer.

16. The body of claim 15, wherein the fibers of the ceramic matrix composite are fibers of aluminum oxide, mullite, silicon carbide, zircon oxide, and/or carbon.

17. The body of claim 15, wherein the ceramic matrix composite comprises SiC/SiC, C/C, C/SiC, Al₂O₃/Al₂O₃, C/siloxane, SiC/siloxane, and/or mullite/mullite.

18. The body of claim 15, wherein the first layer (14) possesses a thickness D₁ with 1 mm≦D_{1≦}20 mm.

19. The body of claim 15, wherein the at least one second layer (16, 26), or all second layers together, exhibit(s) a thickness D₂ with 0 mm<D_{2≦}50 mm.

20. The body of claim 15, wherein the fibers (28, 30) of the first layer (14, 24) are deposited on the base body (12, 22) in a radially revolving and/or criss-crossing pattern.

21. The body of claim 15, wherein the fibers of the at least one second layer (16, 26) are arranged on the first layer in a radially revolving and/or criss-crossing pattern relative to the base body (12, 22).

22. The body of claim 15, wherein the base body (12, 22) comprises martensitic steel.

23. The body of claim 15, wherein the base body (12, 22) comprises a high-alloyed nickel-based alloy.

24. The body of claim 15, wherein the base body (12, 22) possesses a wall thickness D with 1 mm≦D≦50 mm.

25. A pressure-proof fluid-chargeable or fluid-charged body in the form of a pressure pipe or pressure vessel, consisting of a base body of a steel, from the group of martensitic steel, austenitic steel or high-alloyed nickel-base alloy, and at least one layer, which encloses the base body, said body comprising or containing fibers that exhibit no or only minimal creep at a temperature T with T≧500° C.
